(19) United States
(12) Patent Application Publication
(10) Pub. No.: US 2022/0198834 A1
(43) Pub. Date: Jun. 23, 2022

(54) SKELETON RECOGNITION METHOD, STORAGE MEDIUM, AND INFORMATION PROCESSING DEVICE

(71) Applicant: FUJITSU LIMITED, Kawasaki-shi (JP)

(72) Inventor: HIROAKI FUJIMOTO, Kawasaki (JP)

(73) Assignee: FUJITSU LIMITED, Kawasaki-shi (JP)

(21) Appl. No.: 17/690,030

(22) Filed: Mar. 9, 2022

Related U.S. Application Data
(63) Continuation of application No. PCT/JP2019/035979, filed on Sep. 12, 2019.

(51) Int. Cl. G06V 40/20; G06T 7/55; G06T 7/521

(52) U.S. Cl. CPC G06V 40/23; G06T 7/55; G06T 2207/10016; G06T 2200/08; G06T 2207/20044; G06T 7/521

(57) ABSTRACT

A skeleton recognition method for a computer to execute a process includes acquiring distance images from each of a plurality of sensors that sense a subject from a plurality of directions; acquiring joint information that includes joint positions of the subject for each of the plurality of sensors by using a machine learning model that estimates the joint positions from the distance images; generating skeleton information that represents three-dimensional coordinates by integrating the joint information; and outputting the skeleton information of the subject.

### CROSS-REFERENCE TO RELATED APPLICATION

This application is a continuation application of International Application PCT/JP2019/035979 filed on Sep. 12, 2019 and designated the U.S., the entire contents of which are incorporated herein by reference.

### FIELD

The present invention relates to a skeleton recognition method, a storage medium, and an information processing device.

### BACKGROUND

In a wide range of fields such as gymnastics and medical care, recognition of skeletons of persons such as athletes and patients has been performed. For example, a device that recognizes the skeleton of a person based on a distance image output by a three-dimensional (3D) laser sensor (hereinafter, also referred to as a distance sensor or a depth sensor) that senses the distance to the person has been used.

In recent years, a device using two 3D laser sensors that capture a subject from different directions and a learning model learned with a random forest that recognizes a part label image assigned with a part label indicating a part of the body from a distance image has been known.

For example, each distance image acquired from each 3D laser sensor is separately input into the learning models learned with the random forest to acquire each part label image, and pixels in the vicinity of a boundary of each part (boundary pixels) are specified in each part label image. Furthermore, 3D point cloud data obtained by transforming each pixel of the distance image into a point represented by three axes (x, y, z axes) is acquired from each 3D laser sensor. Subsequently, a point cloud corresponding to the boundary pixels is specified in each piece of the 3D point cloud data, and coordinate transformation or the like is performed on one piece of the 3D point cloud data to generate one piece of point cloud data obtained by integrating the two pieces of the 3D point cloud data. Then, the skeleton of the subject is recognized by integrating the two part label images and the point cloud data and calculating the coordinates of each center of gravity in each boundary point cloud in each part label image as the coordinates of each joint position.

Patent Document 1: Japanese Laid-open Patent Publication No. 2009-15671

Patent Document 2: Japanese Laid-open Patent Publication No. 2013-120556

Patent Document 3: International Publication Pamphlet No. WO 2019/069358

### SUMMARY

According to an aspect of the embodiments, a skeleton recognition method for a computer to execute a process includes acquiring distance images from each of a plurality of sensors that sense a subject from a plurality of directions; acquiring joint information that includes joint positions of the subject for each of the plurality of sensors by using a machine learning model that estimates the joint positions from the distance images; generating skeleton information that represents three-dimensional coordinates by integrating the joint information; and outputting the skeleton information of the subject.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overall configuration example of a system including a recognition device according to a first embodiment.

FIG. 2 is a diagram explaining the estimation of joint information using a learning model according to the first embodiment.

FIG. 3 is a diagram explaining skeleton recognition according to the first embodiment.

FIG. 4 is a functional block diagram illustrating a functional configuration of the system according to the first embodiment.

FIG. 5 is a diagram illustrating a definition example of a skeleton.

FIG. 6 is a diagram explaining heat map recognition of each joint.

FIG. 7 is a diagram explaining a three-dimensional skeleton calculation image.

FIG. 8 is a flowchart illustrating a flow of skeleton recognition processing according to the first embodiment.

FIG. 9 is a flowchart illustrating a flow of coordinate transformation processing according to the first embodiment.

FIG. 10 is a flowchart illustrating a flow of integration processing according to the first embodiment.

FIG. 11 is a diagram explaining a skeleton recognition result when both feet are inaccurately regarded as being on one side by a 3D laser sensor B.

FIG. 12 is a diagram explaining a skeleton recognition result when the whole body is flipped laterally by the 3D laser sensor B.

FIG. 13 is a diagram explaining skeleton recognition processing according to a second embodiment.

FIG. 14 is a diagram explaining a skeleton recognition result according to the second embodiment when both feet are inaccurately regarded as being on one side by a 3D laser sensor B.

FIG. 15 is a diagram explaining a skeleton recognition result according to the second embodiment when the whole body is flipped laterally by the 3D laser sensor B.

FIG. 16 is a flowchart illustrating a flow of integration processing according to the second embodiment.

FIG. 17 is a diagram explaining a skeleton recognition result when a deviation between sensors is large.

FIG. 18 is a diagram explaining integration processing according to a third embodiment.

FIG. 19 is a flowchart illustrating a flow of the integration processing according to the third embodiment.

FIG. 20 is a diagram explaining a hardware configuration example.

### DESCRIPTION OF EMBODIMENTS

The approach of integrating the respective part label images obtained by the random forest from the distance images as in the above technology does not have good recognition accuracy for the skeleton of the subject. Specifically, since the joint coordinates are calculated indirectly from the boundary of each part label, it is difficult to enhance the recognition accuracy for a joint in an occlusion portion, where a part of the subject is hidden, even if two 3D radar sensors are used.

For example, taking a pommel horse for the gymnastics competition as an example, description will be given using an example in which occlusion in which the left foot is hidden behind the pommel horse has occurred in a 3D laser sensor A, and no occlusion has occurred in a 3D laser sensor B, among two 3D laser sensors.

In this case, since the random forest performs recognition in units of pixels to estimate the label, the part label of the left foot is not recognizable from a distance image A in which the occlusion has occurred, and the 3D point cloud data of the left foot is not also be acquirable. Therefore, when the two part label images and the point cloud data are integrated, the data of the left foot will depend on a distance image B of the 3D laser sensor B. Accordingly, for example, when a deviation between the distance image A and the distance image B is large, the joints can be recognized at average positions except for the left foot, but the finally recognized skeleton position of the whole body is sometimes irregular because information of the distance image B is used as it is for the left foot. That is, the position of at least one joint (for example, the knee or ankle of the left foot) is not precisely recognizable.

In one aspect, it is an object to provide a skeleton recognition method, a skeleton recognition program, and an information processing device capable of improving the recognition accuracy for the skeleton.

In one aspect, the recognition accuracy for the skeleton may be improved.

Hereinafter, embodiments of a skeleton recognition method, a skeleton recognition program, and an information processing device according to the present invention will be described in detail with reference to the drawings. Note that these embodiments do not limit the present invention. Furthermore, each of the embodiments may be appropriately combined within a range without inconsistency.

### First Embodiment

### Overall Configuration

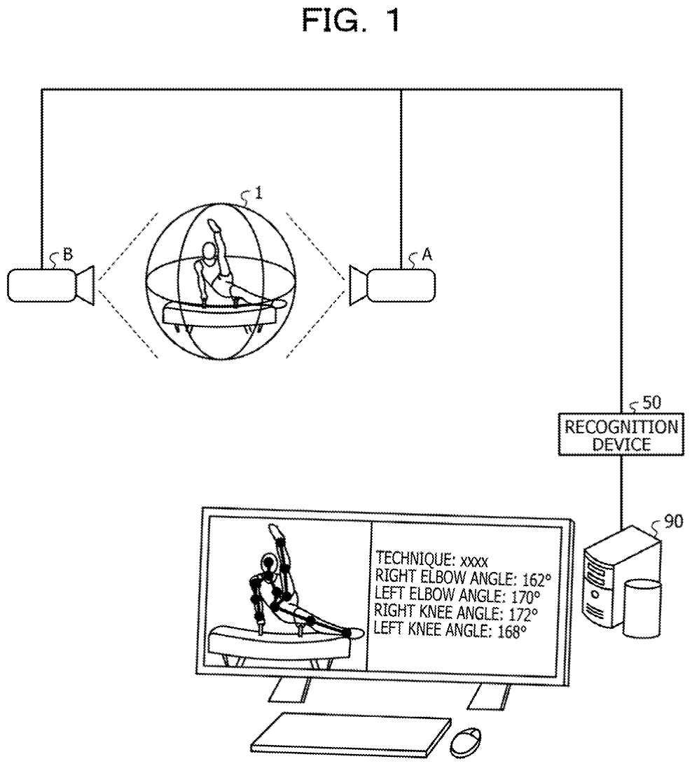

FIG. 1 is a diagram illustrating an overall configuration example of a system including a recognition device according to a first embodiment. As illustrated in FIG. 1, this system includes 3D laser sensors A and B, a recognition device 50, and a scoring device 90 and is a system that captures three-dimensional data of a performer 1 who is a subject and recognizes a skeleton and the like to exactly score techniques. Note that, in the present embodiment, an example of recognizing skeleton information of a performer in a gymnastics competition will be described as an example. Furthermore, in the present embodiment, two-dimensional coordinates of a skeleton position or the skeleton position at the two-dimensional coordinates are sometimes simply described as two-dimensional skeleton position or the like.

Generally, the current scoring method in a gymnastics competition is visually performed by a plurality of scorers. However, with sophistication of techniques, there are increasing cases where it is difficult for the scorers to visually perform scoring. In recent years, an automatic scoring system and a scoring support system for scoring competitions using a 3D laser sensor have been known. For example, in these systems, the 3D laser sensor acquires a distance image, which is three-dimensional data of an athlete, and recognizes a skeleton, which includes, for example, the orientation of each joint and the angle of each joint of the athlete, from the distance image. Then, in the scoring support system, a result of skeleton recognition is displayed by a 3D model, such that the scorers are supported to carry out more precise scoring by, for example, checking a detailed situation of the performer. Furthermore, in the automatic scoring system, a performed technique or the like is recognized from the result of skeleton recognition, and scoring is performed in line with a scoring rule.

Here, in the scoring support system and the automatic scoring system, it is desired to perform scoring support or automatic scoring for the continually performed performances in a timely manner. However, with the conventional approach of learning with the random forest, the recognition accuracy for a joint in an occlusion portion where a part of the subject is hidden has decreased even if two 3D radar sensors are used, which has in turn decreased the scoring accuracy.

For example, in a form in which the result of automatic scoring by the automatic scoring system is provided to the scorer and the scorer compares the provided result with the own scoring result of the scorer, when the conventional technology is used, there is a possibility of making an error in technique recognition due to a decrease in the accuracy of skeleton recognition, which will result in an error also in the score determined by the technique. Similarly, also when the angles and positions of the performer's joints are displayed using a 3D model in the scoring support system, a difficulty in which the time until display is delayed and the displayed angles and the like are not precise may rise. In this case, scoring by the scorer using the scoring support system results in erroneous scoring in some cases.

As described above, the decrease in the accuracy of skeleton recognition in the automatic scoring system or the scoring support system causes the occurrence of erroneous recognition of techniques and wrong scoring, which will lead to a decrease in the reliability of the system.

Thus, in the system according to the first embodiment, by directly estimating joint coordinates from the distance images separately acquired by the 3D laser sensors A and B using a machine learning technology such as deep learning, a three-dimensional skeleton of a performer is recognized at high speed and with high accuracy even when occlusion has occurred.

First, each of the devices constituting the system in FIG. 1 will be described. The 3D laser sensor A (hereinafter, sometimes simply described as a sensor A or the like) is a sensor that captures the performer from the front, and the 3D laser sensor B is a sensor that captures the performer from the rear. Each 3D laser sensor is an example of a sensor device that measures (senses) the distance to a target object for each pixel using an infrared laser or the like. The distance image includes a distance to each pixel. That is, the distance image is a depth image representing a depth of the subject viewed from each 3D laser sensor (depth sensor).

The recognition device 50 is an example of a computer device that recognizes a skeleton relating to the orientation, position, and the like of each joint of the performer 1, using the distance image measured by each 3D laser sensor and a learned learning model. Specifically, the recognition device 50 inputs the distance image measured by each 3D laser sensor into the learned learning model and recognizes the skeleton, based on an output result of the learning model. Thereafter, the recognition device 50 outputs the recognized skeleton to the scoring device 90. Note that, in the present embodiment, information obtained as a result of skeleton recognition is skeleton information regarding the three-dimensional position of each joint.

The scoring device 90 is an example of a computer device that specifies transition of movement obtained from the position and orientation of each joint of the performer, using the skeleton information, which is the recognition result input from the recognition device 50, and executes specification and scoring of a technique performed by the performer 1.

Next, the learning model will be described. The learning model is a model using machine learning such as a neural network and can be generated by the recognition device 50 or also by a learning device (not illustrated) that is a device different from the recognition device 50. Note that one learning model learned using each of the distance images separately captured by the 3D laser sensors A and B can be used. Furthermore, it is also possible to use two learning models A and B learned using each of the distance images separately captured by the 3D laser sensors A and B so as to correspond to the sensors on a one-to-one basis.

The distance image and three-dimensional skeleton position information in the distance image are used for learning of this learning model. For example, when description is given by taking an example of generation by the learning device, the learning device generates a heat map image obtained by projecting likelihoods of a plurality of joint positions of the subject from a plurality of directions, from the three-dimensional skeleton position information. In more detail, the learning device generates a heat map image in a front direction of when the performer is viewed from the front (hereinafter sometimes described as a front heat map, an xy heat map, or the like), and a heat map image in a right above direction of when the performer is viewed from right above (hereinafter sometimes described as a right above heat map, an xz heat map, or the like). Then, the learning device learns the learning model, using training data having the distance image as an explanatory variable and the heat map images in the two directions associated with the distance image as objective variables.

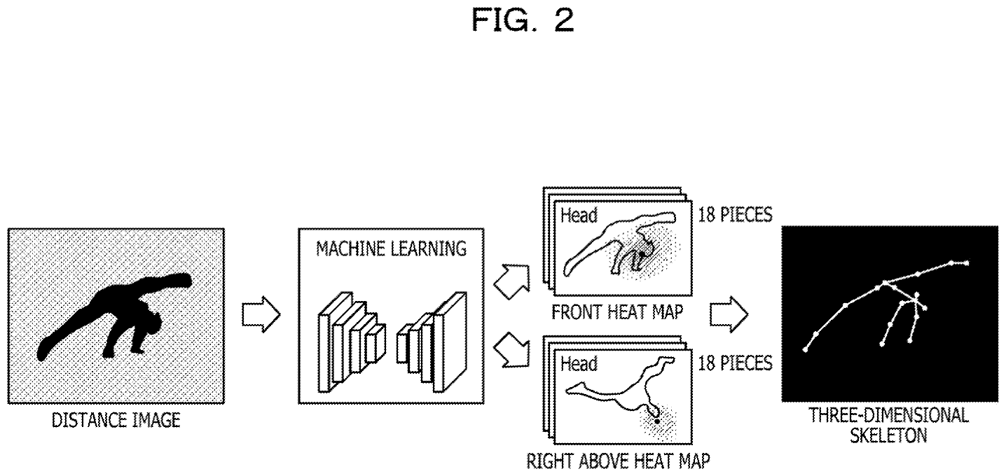

The recognition device 50 according to the first embodiment estimates joint information including the position of each joint, using the learning model learned in this manner. FIG. 2 is a diagram explaining the estimation of the joint information using the learning model according to the first embodiment. As illustrated in FIG. 2, the recognition device 50 acquires the distance image of the performer 1 by each 3D laser sensor and inputs the distance images into the learned learning model to recognize two-dimensional heat map images in the two directions by the number of joints. Then, the recognition device 50 calculates two-dimensional coordinates of the skeleton position on the image from a number of the two-dimensional heat map images equal to the number of joints in each direction and calculates the joint information including three-dimensional coordinates of each joint of the performer 1 from the two-dimensional skeleton position in each direction and the center of gravity of a human area.

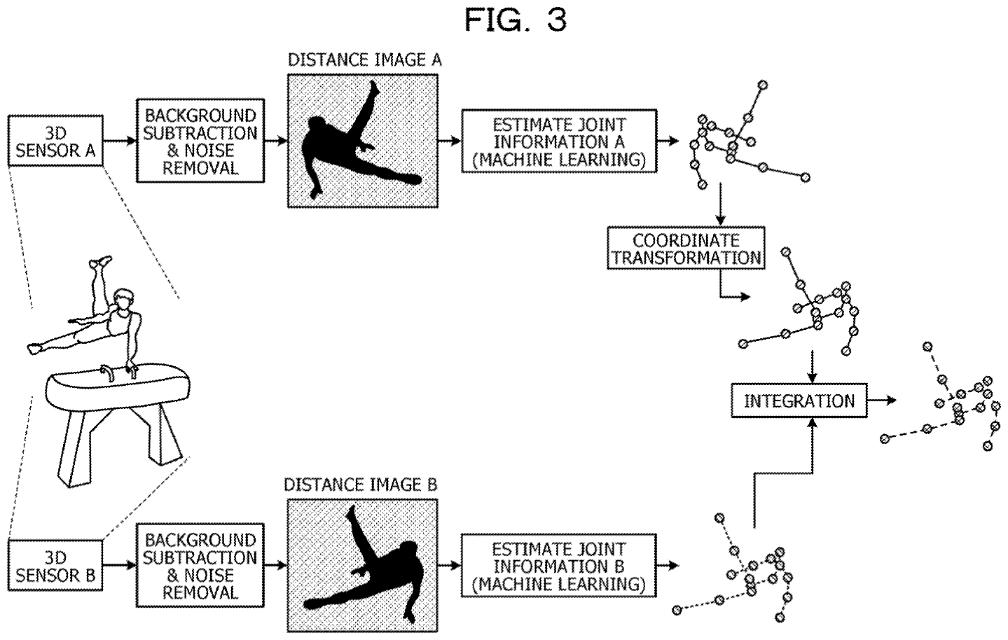

Here, the processing of skeleton recognition of the recognition device 50 using the learning model illustrated in FIG. 2 will be described. FIG. 3 is a diagram explaining skeleton recognition according to the first embodiment. As illustrated in FIG. 3, the recognition device 50 executes background subtraction and noise removal in which an area with no movement between frames is regarded as the background and removed, on the distance image captured by the 3D laser sensor A to generate a distance image A. Subsequently, the recognition device 50 inputs the distance image A into the learned learning model to estimate joint information A (three-dimensional coordinates of each joint) based on the distance image A.

Similarly, the recognition device 50 executes background subtraction and noise removal on the distance image captured by the 3D laser sensor B to generate a distance image B. Subsequently, the recognition device 50 inputs the distance image B into the learned learning model to estimate joint information B based on the distance image B. Thereafter, the recognition device 50 transforms the coordinates of the joint information A so as to adjust the coordinates to a coordinate system of the joint information B and integrates the transformed joint information A and the joint information B to generate the skeleton information indicating the three-dimensional skeleton position of the performer 1.

In this manner, the recognition device 50 calculates the joint positions including the joint coordinates of the whole body for each sensor and thereafter, integrates the joint positions after adjusting the coordinate systems of both of the sensors to each other, thereby outputting a final skeleton position of the whole body. As a result, even when occlusion has occurred, the three-dimensional skeleton of the performer may be recognized at high speed and with high accuracy.

### Functional Configuration

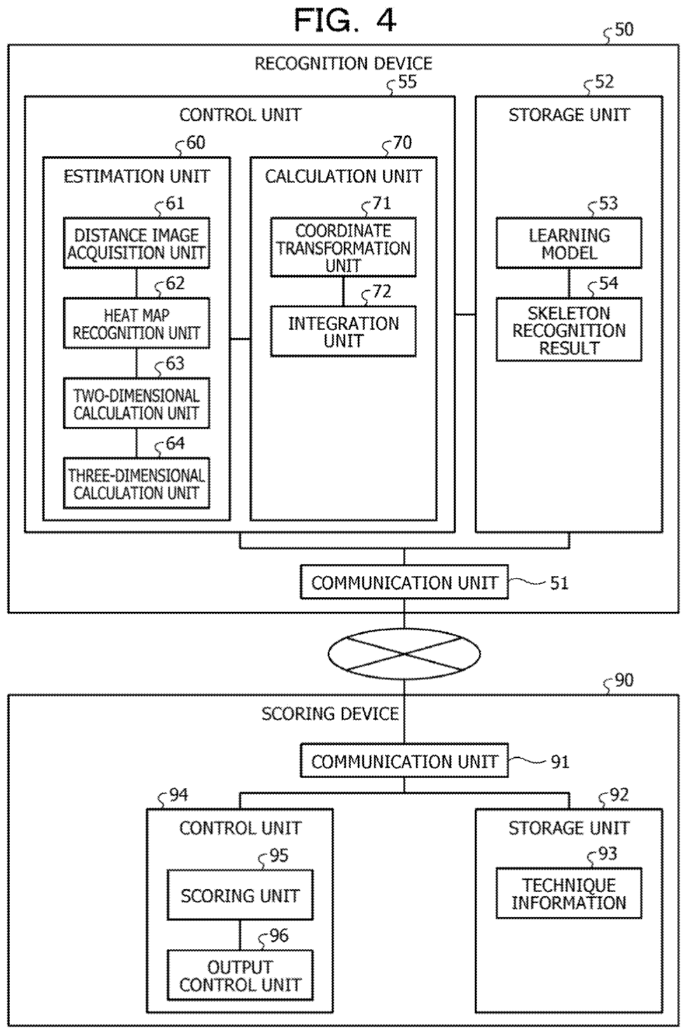

FIG. 4 is a functional block diagram illustrating a functional configuration of the system according to the first embodiment. Here, the recognition device 50 and the scoring device 90 will be described.

### Recognition Device 50

As illustrated in FIG. 4, the recognition device 50 includes a communication unit 51, a storage unit 52, and a control unit 55. The communication unit 51 is a processing unit that controls communication between other devices and, for example, is a communication interface or the like. For example, the communication unit 51 receives the distance image captured by each 3D laser sensor and transmits the recognition result and the like to the scoring device 90.

The storage unit 52 is an example of a storage device that stores data and a program or the like executed by the control unit 55 and, for example, is a memory, a hard disk, or the like. This storage unit 52 stores a learning model 53 and a skeleton recognition result 54.

The learning model 53 is a learned learning model that has been learned by machine learning or the like. Specifically, the learning model 53 is a learning model that predicts 18 front heat map images and 18 right above heat map images corresponding to each joint from the distance images. Note that the learning model 53 may be made up of two learning models that have been separately learned to recognize each heat map image from the distance image of the relevant sensor so as to correspond to the respective 3D laser sensors on a one-to-one basis. In addition, the learning model 53 may be one learning model that has been learned to recognize each heat map image from each distance image captured by each 3D laser sensor.

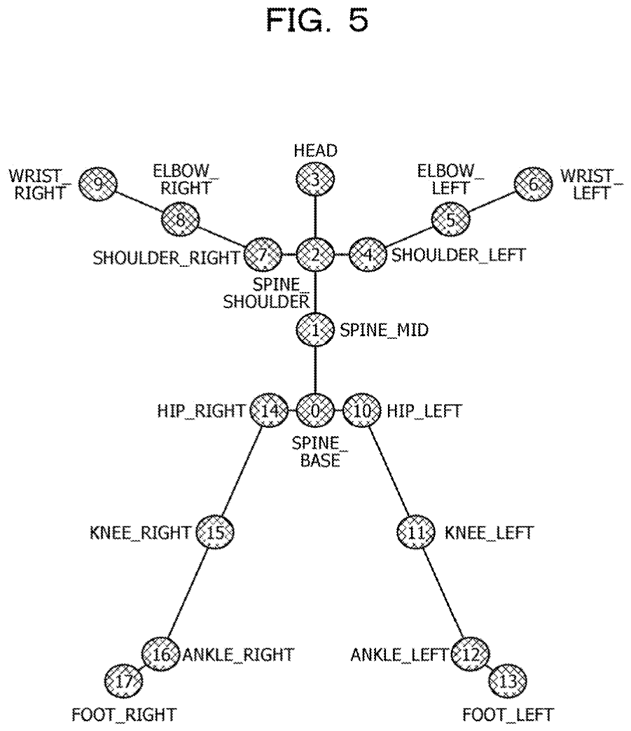

Here, each heat map image is a heat map image corresponding to the relevant one of 18 joints defined on a skeleton model. Here, the 18 joints are defined in advance. FIG. 5 is a diagram illustrating a definition example of a skeleton. As illustrated in FIG. 5, the skeleton definition has 18 pieces (numbers 0 to 17) of definition information in which respective joints specified in a known skeleton model are numbered. For example, as illustrated in FIG. 5, a right shoulder joint (SHOULDER_RIGHT) is assigned with number 7, a left elbow joint (ELBOW_LEFT) is assigned with number 5, a left knee joint (KNEE_LEFT) is assigned with number 11, and a right hip joint (HIP_RIGHT) is assigned with number 14. Here, in the embodiment, for the right shoulder joint with number 8, an X coordinate is described as X8, a Y coordinate is described as Y8, and a Z coordinate is described as Z8 in some cases. Note that, for example, a Z axis can be defined as a distance direction from the 3D laser sensor 5 toward a target, a Y axis can be defined as a height direction perpendicular to the Z axis, and an X axis can be defined as a horizontal direction. The definition information stored here may be measured for each performer by 3D sensing with the 3D laser sensor or may be defined using a skeleton model of a general system.

The skeleton recognition result 54 is the skeleton information of the performer 1 recognized by the control unit 55 described later. For example, the skeleton recognition result 54 has information in which the captured frame of each performer is associated with the three-dimensional skeleton position calculated from the distance image of that frame.

The control unit 55 is a processing unit that is in charge of the entire recognition device 50 and, for example, is a processor or the like. This control unit 55 includes an estimation unit 60 and a calculation unit 70 and executes skeleton recognition for the performer 1. Note that the estimation unit 60 and the calculation unit 70 are examples of electronic circuits included in the processor and examples of processes executed by the processor.

The estimation unit 60 includes a distance image acquisition unit 61, a heat map recognition unit 62, a two-dimensional calculation unit 63, and a three-dimensional calculation unit 64 and is a processing unit that estimates the joint information (skeleton recognition) indicating the three-dimensional joint position from the distance image.

The distance image acquisition unit 61 is a processing unit that acquires the distance image from each 3D laser sensor. For example, the distance image acquisition unit 61 acquires the distance image captured by the 3D laser sensor A. Then, the distance image acquisition unit 61 performs background subtraction that removes equipment such as the pommel horse and the background to leave only an area of a person, and noise removal that performs removal of a pixel that appears in an empty place, smoothing noise on a surface of the human body due to an error, and the like, on the acquired distance image and outputs the distance image obtained as a result of the background subtraction and the noise removal to the heat map recognition unit 62.

In this manner, the distance image acquisition unit 61 acquires the distance image A from the 3D laser sensor A and acquires the distance image B from the 3D laser sensor B to output each distance image to the heat map recognition unit 62. Note that the distance image acquisition unit 61 can also store the distance image in the storage unit 52 or the like in association with each performer.

The heat map recognition unit 62 is a processing unit that recognizes the heat map images from the distance image using the learned learning model 53. For example, the heat map recognition unit 62 reads the learning model 53 that has been learned using a neural network, from the storage unit 52. Then, the heat map recognition unit 62 inputs the distance image A acquired from the 3D laser sensor A into the learning model 53 to acquire each heat map image. Similarly, the heat map recognition unit 62 inputs the distance image B acquired from the 3D laser sensor B into the learning model 53 to acquire each heat map image.

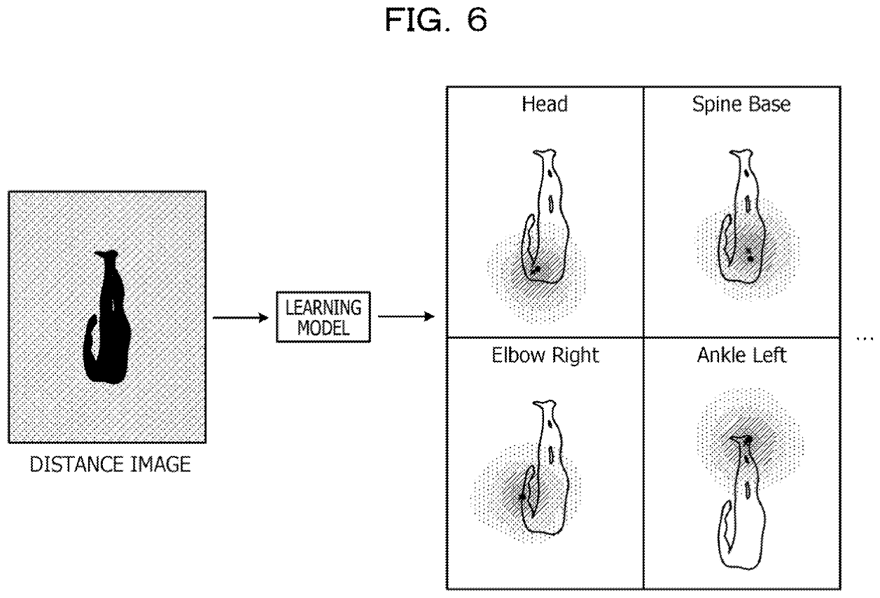

FIG. 6 is a diagram explaining heat map recognition of each joint. As illustrated in FIG. 6, the heat map recognition unit 62 inputs the distance images acquired from the distance image acquisition unit 61 into the learned learning model 53 and acquires, as output results, the front heat map images relating to each of the 18 joints and the right above heat map images relating to each of the 18 joints. Then, the heat map recognition unit 62 outputs each of the heat map images recognized in this manner to the two-dimensional calculation unit 63.

Note that, as illustrated in FIG. 6, the distance image is data including the distance from the 3D laser sensor to the pixel, and the closer the distance from the 3D laser sensor, the darker the color is displayed. Furthermore, the heat map image is generated for each joint and is an image that visualizes the likelihood of each joint position, in which the coordinate position having the highest likelihood is displayed in the darkest color. Note that, although the shape of a person is not displayed in the heat map image normally, FIG. 6 illustrates the shape of the person for easy understanding of the description but does not limit the display format of the image.

The two-dimensional calculation unit 63 is a processing unit that calculates the skeleton on the image from the two-dimensional heat map images. Specifically, the two-dimensional calculation unit 63 uses each heat map image separately corresponding to the 3D laser sensors to calculate the two-dimensional coordinates of each indirect (skeleton position) on the image for each of the 3D laser sensors A and B. For example, the two-dimensional calculation unit 63 calculates two-dimensional coordinates A of each joint based on each heat map image recognized from the distance image A of the 3D laser sensor A, and two-dimensional coordinates B of each joint based on each heat map image recognized from the distance image B of the 3D laser sensor B to output the respective two-dimensional coordinates A and B to the three-dimensional calculation unit 64.

For example, the two-dimensional calculation unit 63 acquires the front heat map images relating to the 18 joints and the right above heat map images relating to the 18 joints. Then, the two-dimensional calculation unit 63 specifies the position of each joint from a highest value pixel of each heat map image and calculates the two-dimensional coordinates of the skeleton position on the image to output the calculated two-dimensional coordinates to the three-dimensional calculation unit 64.

That is, the two-dimensional calculation unit 63 specifies a pixel with the highest value in the heat map image for each of the front heat map images relating to the 18 joints to individually specify the position of each joint on the image. Then, the two-dimensional calculation unit 63 combines the joint positions specified from the respective front heat map images to specify 18 joint positions when the performer 1 is viewed from the front.

Similarly, the two-dimensional calculation unit 63 specifies a pixel with the highest value in the heat map image for each of the right above heat map images relating to the 18 joints to individually specify the position of each joint on the image. Then, the two-dimensional calculation unit 63 combines the joint positions specified from the respective right above heat map images to specify 18 joint positions when the performer 1 is viewed from right above.

Using such an approach, the two-dimensional calculation unit 63 uses the two-dimensional coordinates A of the performer's skeleton position corresponding to the 3D laser sensor A to specify the 18 joint positions when viewed from the front and the joint positions when viewed from right above and outputs the specified joint positions to the three-dimensional calculation unit 64. Furthermore, the two-dimensional calculation unit 63 uses the two-dimensional coordinates B of the performer's skeleton position corresponding to the 3D laser sensor B to specify the 18 joint positions when viewed from the front and the joint positions when viewed from right above and outputs the specified joint positions to the three-dimensional calculation unit 64.

The three-dimensional calculation unit 64 is a processing unit that calculates the joint information (skeleton recognition) indicating each three-dimensional joint position, using the two-dimensional skeleton positions in the front direction and the right above direction and the center of gravity of the human area. Specifically, the three-dimensional calculation unit 64 calculates the three-dimensional joint information A using the two-dimensional coordinates A of the joint position calculated based on the distance image A of the 3D laser sensor A, and calculates the three-dimensional joint information B using the two-dimensional coordinates B of the joint position calculated based on the distance image B of the 3D laser sensor B. Then, the three-dimensional calculation unit 64 outputs each piece of joint information, which is three-dimensional coordinates, to the calculation unit 70.

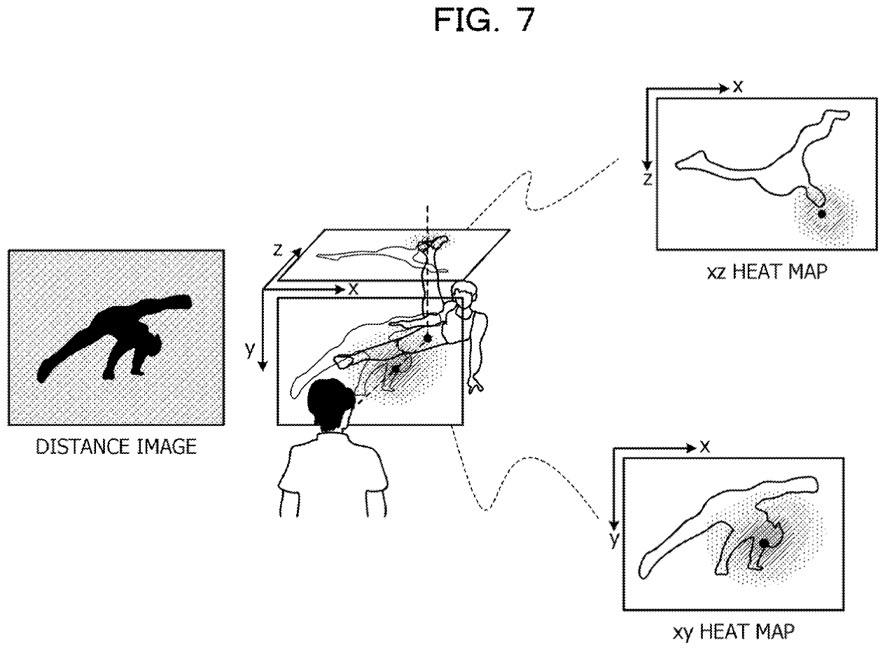

Here, an image at the time of calculating a three-dimensional skeleton will be described. FIG. 7 is a diagram explaining a three-dimensional skeleton calculation image. As illustrated in FIG. 7, the distance image captured in the present embodiment is, for example, a distance image in x-axis and y-axis directions (sometimes simply described as a distance image or an xy distance image) in a case where the horizontal direction of the performer is assumed as the x axis, the vertical direction thereof is assumed as the y axis, and the depth direction thereof is assumed the z axis.

Furthermore, the front heat map images relating to the 18 joints recognized by the heat map recognition unit 62 are images when the performer 1 is viewed from the front and are xy heat map images captured in the x-axis-y-axis direction. In addition, the right above heat map images relating to the 18 joints recognized by the heat map recognition unit 62 are images when the performer 1 is viewed from right above and are xz heat map images captured in the x-axis-z-axis direction.

The three-dimensional calculation unit 64 calculates the center of gravity of the human area showing on the distance image (hereinafter sometimes described as human center of gravity) and calculates depth values for the 18 joints from the human center of gravity and the two-dimensional skeleton positions on the xz heat map images. Then, the three-dimensional calculation unit 64 calculates the joint information, which is the three-dimensional position information of each joint (three-dimensional coordinates of the skeleton position), using the depth values for the 18 joints and the two-dimensional skeleton positions on the xy heat map images.

For example, the three-dimensional calculation unit 64 acquires the distance image of the performer from the distance image acquisition unit 61. Here, the distance image includes pixels on which a person shows, and each pixel stores a Z value from the 3D image sensor to the person (performer 1). The Z value is a pixel value of the pixel on which a person shows on the distance image. Note that, generally, among values obtained by transforming distance information of the distance image into coordinate values represented by coordinate axes of x, y, and z in orthogonal coordinates, a value in the z axis, which is a direction from the 3D image sensor toward the subject, is referred to as the Z value.

Thus, the three-dimensional calculation unit 64 specifies each pixel that is located at a distance from the 3D image sensor less than a threshold value and has a pixel value equal to or greater than a fixed value. That is, the three-dimensional calculation unit 64 specifies the performer 1 on the distance image. Then, the three-dimensional calculation unit 64 calculates an average value of the pixel values of the specified respective pixels, as the center of gravity of the human area.

Subsequently, the three-dimensional calculation unit 64 calculates the depth values for the 18 joints, using the center of gravity of the human area and the two-dimensional skeleton positions on right above images, which are images when the performer 1 is viewed from right above. For example, the three-dimensional calculation unit 64 specifies pixels each having the pixel value equal to or greater than a fixed value, from the respective right above heat map images (xz heat map images) relating to the 18 joints acquired from the heat map recognition unit 62 and specifies an area of the image in which the performer shows. Then, the three-dimensional calculation unit 64 calculates the two-dimensional coordinates (x, z) of the human area specified on each xy heat map image.

Here, the distance image is created with, for example, 1 pixel=10 mm such that the center of gravity of the person comes at the center of the image. Accordingly, the three-dimensional calculation unit 64 can calculate the Z value in the three-dimensional space according to how apart the z value of the two-dimensional coordinates (x, z) of the human area specified on each xy heat map image is from the center of the distance image. For example, when description is given by taking an example assuming that an image size is (320, 320), the center of the image is (160, 160), the center of gravity of the human area is 6000 mm, and the z value of the head is 200, the three-dimensional calculation unit 64 calculates the Z value in the three-dimensional space as “(200−160)×10+6000=6400 mm”.

Thereafter, the three-dimensional calculation unit 64 calculates the three-dimensional coordinates of the skeleton position of the performer 1, using the depth values for the 18 joints and the two-dimensional skeleton position on the xy heat map images recognized by the heat map recognition unit 62. For example, the three-dimensional calculation unit 64 acquires the Z values in the three-dimensional space, which are the depth values for the 18 joints, calculates the two-dimensional coordinates of (x, y) on the image from the xy heat map images, using the above approach, and calculates a vector in the three-dimensional space from the two-dimensional coordinates (x, y).

For example, the distance image captured by a three-dimensional sensor such as the 3D laser sensor has three-dimensional vector information that passes through each pixel from the origin of the sensor. Therefore, by using this information, the three-dimensional coordinate values of the object showing on each pixel can be calculated. Then, the three-dimensional calculation unit 64 can calculate (X, Y, Z) of the object (performer 1) showing at the (x, y) coordinates, by using equation (1), where the three-dimensional vector of the (x, y) coordinates on the xy heat map image is assumed as (normX, normY, normZ), and the Z value of these coordinates is assumed as “pixelZ”. In this manner, the three-dimensional calculation unit 64 calculates the three-dimensional coordinates (X, Y, Z) of the object showing on each pixel, which is each joint of the performer 1.

$$\begin{matrix} [ Mathematical Formula 1 ] & \\ Coordinate Values of Object = ( X = normX * \frac{Z}{normZ} , Y = normY * \frac{Z}{n o r m Z} , Z = pixelZ ) & Equation ( 1 )\end{matrix}$$

Using the approach described above, the three-dimensional calculation unit 64 calculates the joint information A, which is the three-dimensional coordinates of each joint of the performer 1, based on the distance image A of the 3D laser sensor A and also calculates the joint information B, which is the three-dimensional coordinates of each joint of the performer 1, based on the distance image B of the 3D laser sensor B. Then, the three-dimensional calculation unit 64 outputs the joint information A and the joint information B to the calculation unit 70.

Returning to FIG. 4, the calculation unit 70 includes a coordinate transformation unit 71 and an integration unit 72 and is a processing unit that calculates the three-dimensional skeleton position of the performer 1 using the two pieces of the joint information calculated by the three-dimensional calculation unit 64.

The coordinate transformation unit 71 is a processing unit that executes coordinate transformation for adjusting the coordinate system of one 3D laser sensor to the coordinate system of the other 3D laser sensor. Note that the unified coordinate system is also called a reference coordinate system. Specifically, the coordinate transformation unit 71 performs processing of adjusting the coordinate system of one sensor to the coordinate system of the other sensor using affine transformation parameters calculated in advance by performing calibration at the time of sensor installation. This example illustrates an example of matching one coordinate system with the other, but when the coordinate systems are adjusted to a new coordinate system different from the coordinate systems of both of the sensors, the coordinate transformation is applied to the results of both of the sensors.

Here, an example of performing coordinate transformation by multiplying the input coordinates (x, y, z) by a matrix of each of rotation around the x axis, rotation around the y axis, rotation around the z axis, and translation will be described. The rotation around the x axis is defined by equation (2), and here, Rₓ(θ) is defined as equation (3). Similarly, the rotation around the y axis is defined by equation (4), and here, R_{y}(θ) is defined as equation (5). Furthermore, the rotation around the z axis is defined by equation (6), and R_{z}(θ) is defined as equation (7). The translation is defined by equation (8), and here, T is defined as equation (9). Note that θₓᵣₒₜ, which represents the x-axis centered rotation angle, θ_{yrot}, which represents the y-axis centered rotation angle, θ_{zrot}, which represents the z-axis centered rotation angle, tₓ, which represents the x-axis translation, t_{y}, which represents the y-axis translation, and t_{z}, which represents the z-axis translation, are assumed.

$$\begin{matrix}[ Mathematical Formula 2 ] & \\ ( \begin{matrix}{x}^{′} \\ {y}^{′} \\ {z}^{′} \\ 1\end{matrix} ) = ( \begin{matrix}1 & 0 & 0 & 0 \\ 0 & cos θ & - sin θ & 0 \\ 0 & sin θ & cos θ & 0 \\ 0 & 0 & 0 & 1\end{matrix} ) ( \begin{matrix}x \\ y \\ z \\ 1\end{matrix} ) & Equation ( 2 ) \\ [ Mathematical Formula 3 ] & \\ {R}_{x} ( θ ) = ( \begin{matrix}1 & 0 & 0 & 0 \\ 0 & cos θ & - sin θ & 0 \\ 0 & sin θ & cos θ & 0 \\ 0 & 0 & 0 & 1\end{matrix} ) & Equation ( 3 ) \\ [ Mathematical Formula 4 ] & \\ ( \begin{matrix}{x}^{′} \\ {y}^{′} \\ {z}^{′} \\ 1\end{matrix} ) = ( \begin{matrix}cos θ & 0 & sin θ & 0 \\ 0 & 1 & 0 & 0 \\ - sin θ & 0 & cos θ & 0 \\ 0 & 0 & 0 & 1\end{matrix} ) ( \begin{matrix}x \\ y \\ z \\ 1\end{matrix} ) & Equation ( 4 ) \\ [ Mathematical Formula 5 ] & \\ {R}_{y} ( θ ) = ( \begin{matrix}cos θ & 0 & sin θ & 0 \\ 0 & 1 & 0 & 0 \\ - sin θ & 0 & cos θ & 0 \\ 0 & 0 & 0 & 1\end{matrix} ) & Equation ( 5 ) \\ [ Mathematical Formula 6 ] & \\ ( \begin{matrix}{x}^{′} \\ {y}^{′} \\ {z}^{′} \\ 1\end{matrix} ) = ( \begin{matrix}cos θ & sin θ & 0 & 0 \\ sin θ & cos & 0 & 0 \\ 0 & 0 & 1 & 0 \\ 0 & 0 & 0 & 1\end{matrix} ) ( \begin{matrix}x \\ y \\ z \\ 1\end{matrix} ) & Equation ( 6 ) \\ [ Mathematical Formula 7 ] & \\ {R}_{z} ( θ ) = ( \begin{matrix}cos θ & sin θ & 0 & 0 \\ sin θ & cos & 0 & 0 \\ 0 & 0 & 1 & 0 \\ 0 & 0 & 0 & 1\end{matrix} ) & Equation ( 7 ) \\ [ Mathematical Formula 8 ] & \\ ( \begin{matrix}{x}^{′} \\ {y}^{′} \\ {z}^{′} \\ 1\end{matrix} ) = ( \begin{matrix}1 & 0 & 0 & {t}_{x} \\ 0 & 1 & 0 & {t}_{y} \\ 0 & 0 & 1 & {t}_{z} \\ 0 & 0 & 0 & 1\end{matrix} ) ( \begin{matrix}x \\ y \\ z \\ 1\end{matrix} ) & Equation ( 8 ) \\ [ Mathematical Formula 9 ] & \\ T = ( \begin{matrix}1 & 0 & 0 & {t}_{x} \\ 0 & 1 & 0 & {t}_{y} \\ 0 & 0 & 1 & {t}_{z} \\ 0 & 0 & 0 & 1\end{matrix} ) & Equation ( 9 )\end{matrix}$$

In this manner, the coordinate transformation unit 71 can execute transformation equivalent to transformation of the affine transformation matrix using equations (10) and (11) by transforming in the order described above.

$$\begin{matrix}[ Mathematical Formula 10 ] & \\ Q = {R}_{C} ( θ ) {R}_{y} ( θ ) {R}_{z} ( θ ) T & Equation ( 10 ) \\ [ Mathematical Formula 11 ] & \\ ( \begin{matrix}{x}^{′} \\ {y}^{′} \\ {z}^{′} \\ 1\end{matrix} ) = Q ( \begin{matrix}x \\ y \\ z \\ 1\end{matrix} ) & Equation ( 11 )\end{matrix}$$

Then, the coordinate transformation unit 71 performs the above-described coordinate transformation on the joint information A, which is the three-dimensional skeleton of the performer 1 corresponding to the 3D laser sensor A, to transform the joint information A to the same coordinate system as the coordinate system of the joint information B corresponding to the 3D laser sensor B. Thereafter, the coordinate transformation unit 71 outputs the joint information A after the coordinate transformation to the integration unit 72.

The integration unit 72 is a processing unit that integrates the joint information A and the joint information B to calculate the three-dimensional skeleton information of the performer 1. Specifically, the integration unit 72 calculates an average value of the joint information A and the joint information B for each of the 18 joints illustrated in FIG. 5. For example, in regard to HEAD with the joint number 3 illustrated in FIG. 5, the integration unit 72 calculates the average value of the three-dimensional coordinates of HEAD included in the joint information A and the three-dimensional coordinates of HEAD included in the joint information B, as the final joint position.

In this manner, the integration unit 72 calculates the average value of each joint as the final three-dimensional skeleton information of the performer 1. Then, the integration unit 72 transmits the calculated skeleton information to the scoring device 90. Note that information such as a frame number and time information may be output to the scoring device 90 in association with the three-dimensional coordinates of each joint.

Returning to FIG. 4, the scoring device 90 includes a communication unit 91, a storage unit 92, and a control unit 94. The communication unit 91 receives the skeleton information (three-dimensional skeleton position information) of the performer from the recognition device 50.

The storage unit 92 is an example of a storage device that stores data and a program or the like executed by the control unit 94 and, for example is a memory, a hard disk, or the like. This storage unit 92 stores technique information 93. The technique information 93 is, for example, information regarding a technique of the pommel horse and is information in which the name of the technique, the difficulty level, the score, the position of each joint, the angle of the joint, the scoring rule, and the like are associated with each other.

The control unit 94 is a processing unit that is in charge of the entire scoring device 90 and, for example, is a processor or the like. This control unit 94 includes a scoring unit 95 and an output control unit 96 and, for example, scores a technique in accordance with the skeleton information of the performer 1 recognized by the recognition device 50.

The scoring unit 95 is a processing unit that executes scoring of the technique of the performer. Specifically, the scoring unit 95 compares the three-dimensional skeleton positions continually transmitted from the recognition device 50 with the technique information 93 to execute scoring of the technique performed by the performer 1. Then, the scoring unit 95 outputs the scoring result to the output control unit 96.

For example, the scoring unit 95 specifies the joint information of the technique being performed by the performer 1 from the technique information 93. Then, the scoring unit 95 compares the predefined joint information of the technique with the three-dimensional skeleton position acquired from the recognition device 50 and extracts the exactness, deductions, and the like of the technique of the performer 1 depending on the magnitude of the error and the like to score the technique. Note that the scoring method for the technique is not limited to this scoring method, and scoring is performed in accordance with a predefined scoring rule.

The output control unit 96 is a processing unit that displays, for example, the scoring result of the scoring unit 95 on a display or the like. For example, the output control unit 96 acquires various types of information from the recognition device 50, such as the distance image captured by each 3D laser sensor, the three-dimensional skeleton information calculated by the calculation unit 70, each piece of image data during the performance of the performer 1, and the scoring result, to display the acquired various types of information on a predetermined screen.

### Flow of Processing

Next, each piece of processing executed by the above-described system will be described. Here, each of skeleton recognition processing, coordinate transformation processing, and integration processing will be described.

### Skeleton Recognition Processing

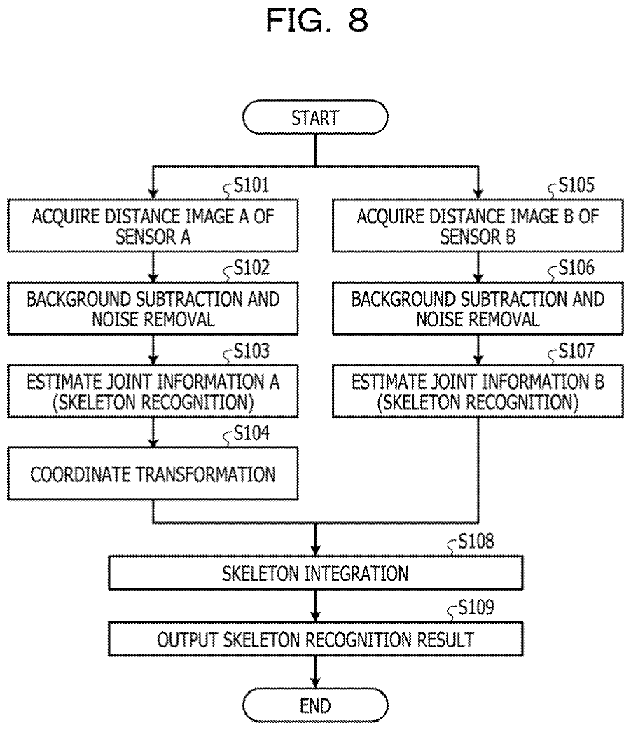

FIG. 8 is a flowchart illustrating a flow of the skeleton recognition processing according to the first embodiment. As illustrated in FIG. 8, the estimation unit 60 of the recognition device 50 acquires the distance image A from the 3D laser sensor A (S101) and executes the background subtraction and the noise removal on the distance image A (S102).

Subsequently, the estimation unit 60 estimates the joint information A of the performer 1 by executing heat map recognition using the learning model 53, calculation of the two-dimensional coordinates, calculation of the three-dimensional coordinates, and the like (S103). Then, the calculation unit 70 executes the coordinate transformation for the estimated joint information A in order to adjust the estimated joint information A to the other coordinate system (S104).

In parallel with the above processing, the estimation unit 60 of the recognition device 50 acquires the distance image B from the 3D laser sensor B (S105) and executes the background subtraction and the noise removal on the distance image B (S106). Subsequently, the estimation unit 60 estimates the joint information B of the performer 1 by executing heat map recognition using the learning model 53, calculation of the two-dimensional coordinates, calculation of the three-dimensional coordinates, and the like (S107).

Thereafter, the calculation unit 70 integrates the joint information A and the joint information B to generate the three-dimensional coordinates of each joint (S108) and outputs the generated three-dimensional coordinates of each joint as a skeleton recognition result (S109).

### Coordinate Transformation Processing

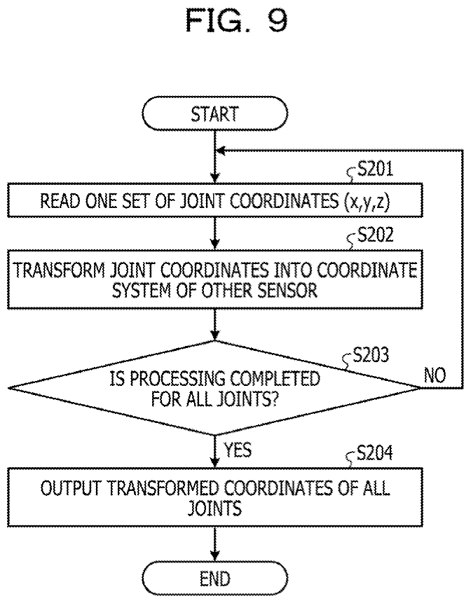

FIG. 9 is a flowchart illustrating a flow of the coordinate transformation processing according to the first embodiment. This processing is processing executed in S104 in FIG. 8.

As illustrated in FIG. 9, the calculation unit 70 of the recognition device 50 reads the joint coordinates of a certain joint included in one piece of the joint information (S201) and transforms the read joint coordinates into the coordinate system of the other 3D laser sensor (S202). Then, the calculation unit 70 repeats S201 and subsequent steps until the processing is completed for all the joints (S203: No) and, when the processing is completed for all the joints (S203: Yes), outputs the transformed coordinates of all the indirects as the joint information after the coordinate transformation (S204).

For example, the coordinate transformation by the calculation unit 70 is performed using rotation and translation parameters for transforming the point cloud of each sensor into an integrated coordinate system. The affine transformation matrix is determined by performing calibration at the time of sensor installation and finding parameters of the X-axis centered rotation angle, Y-axis centered rotation angle, Z-axis centered rotation angle, X-axis translation, Y-axis translation, Z-axis translation, the order of rotation and translation, and the like, and the XYZ coordinates of the joint can be transformed.

### Integration Processing

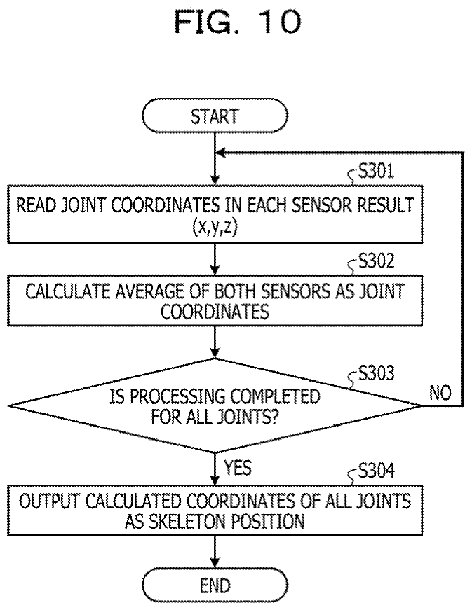

FIG. 10 is a flowchart illustrating a flow of the integration processing according to the first embodiment. This processing is processing executed in S108 in FIG. 8.

As illustrated in FIG. 10, the calculation unit 70 reads each joint coordinate of a certain joint from each piece of the joint information estimated from the distance image of the relevant sensor (S301) and calculates the average value of each set of the joint coordinates as the joint position (S302).

Then, the calculation unit 70 repeats S301 and subsequent steps until the joint positions are calculated for all the joints (S303: No) and, when the joint positions have been calculated for all the joints (S303: Yes), outputs the calculated coordinates of all the joints as the skeleton position (three-dimensional skeleton information) (S304).

### Effects

As described above, the recognition device 50 acquires the distance images from each of the plurality of 3D laser sensors that separately sense the performer 1 from a plurality of directions. Then, the recognition device 50 acquires tentative skeleton information of the performer 1 for each of the plurality of 3D laser sensors, based on the distance image of each of the plurality of 3D laser sensors and the learning model for obtaining the joint position of a human from the distance image. Thereafter, the recognition device 50 integrates the tentative skeleton information of the performer 1 from each of the plurality of 3D laser sensors to generate the skeleton information of the performer 1.

In this manner, the recognition device 50 may generate a skeleton recognition result, on the basis of the results of sensing separately conducted by the two 3D laser sensors installed ahead and behind the performer 1. Accordingly, since it is possible to directly estimate the joint position and generate the skeleton information, position information on the 18 joints may be predicted from the distance images, as compared with the approach of indirectly estimating the joint position as in the conventional random forest, and even when occlusion has occurred in one joint, the position information on all the 18 joints may be predicted from the relationship in the position information between the remaining 17 joints. Moreover, by integrating two pieces of the position information on the joints in different directions, the recognition accuracy for the skeleton may be further improved than using the position information in only one direction.

### Second Embodiment

Incidentally, in the approach according to the first embodiment, since the respective pieces of the joint information are integrated by averaging, if one piece of the joint information has an inaccuracy, the coordinates of an empty space are calculated as the joint coordinates, and the recognition accuracy for the skeleton decreases in some cases. For example, when a person is upright or handstanding, it is difficult to distinguish between the front and the back only with the 3D shape, and there is a case where the left and right (or the front and back) are recognized as inverted, which will sometimes cause a result significantly apart from the human shape when only one pieces of the joint information is inverted.

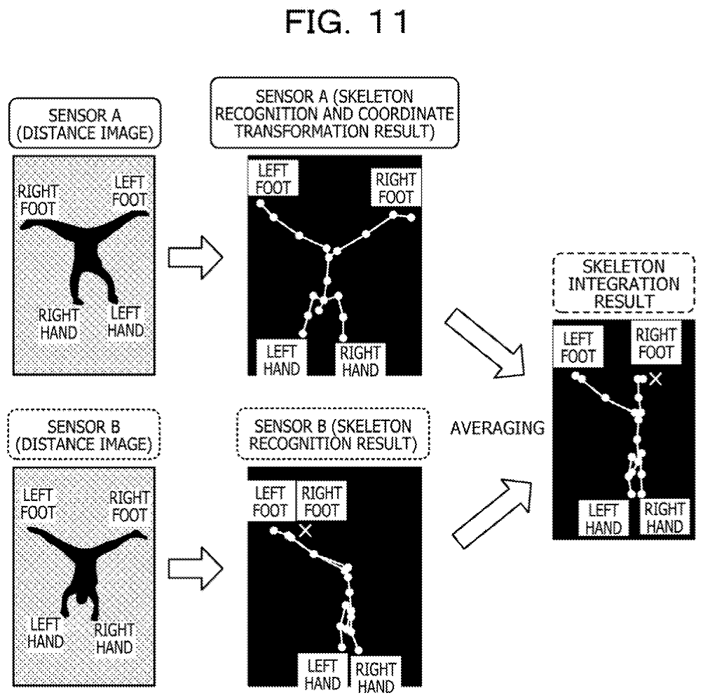

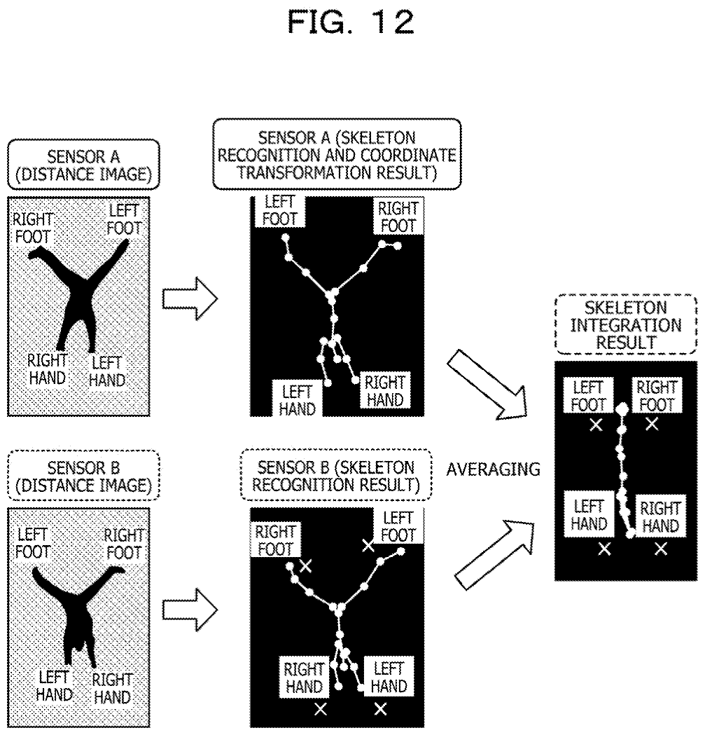

Here, an example in which the recognition accuracy for the skeleton is decreased will be described with reference to FIGS. 11 and 12. Here, in order to make the explanation easy to understand, the joint information estimated using the distance image will be described using the skeleton position (skeleton recognition result) obtained by plotting each joint included in the relevant piece of the joint information.

FIG. 11 is a diagram explaining a skeleton recognition result when both feet are inaccurately regarded as being on one side by the 3D laser sensor B. As illustrated in FIG. 11, in a skeleton recognition result A recognized using the distance image A of the sensor A, both hands and both feet are all precisely recognized. On the other hand, in a skeleton recognition result B recognized using the distance image B of the sensor B, the right foot and the left foot are recognized at the same position, which is an inaccurate recognition result. When such recognition results are integrated by the approach of the first embodiment, since each joint position is determined by the average value of the coordinates of the relevant joint, the position of the right foot is placed nearer to the left foot, and the precise skeleton position is not obtained, which will decrease the recognition accuracy for the skeleton information.

FIG. 12 is a diagram explaining a skeleton recognition result when the whole body is flipped laterally by the 3D laser sensor B. As illustrated in FIG. 12, in a skeleton recognition result A recognized using the distance image A of the sensor A, both hands and both feet are all precisely recognized. On the other hand, in a skeleton recognition result B recognized using the distance image B of the sensor B, the right hand and the left hand are laterally reversed, and additionally, the right foot and the left foot are recognized at positions laterally reversed, which is an inaccurate recognition result. When such recognition results are integrated by the approach of the first embodiment, since each joint position is determined by the average value of the coordinates of the relevant joint, a skeleton position in which both feet are located at the same position and both hands are located at the same position is obtained, which will decrease the recognition accuracy for the skeleton information.

Thus, in a second embodiment, an integration result of the previous frame is retained, and when the integration is performed for the current frame, the integration result of the previous frame is used to improve the accuracy when one piece of the joint information is erroneous. Note that the frame indicates an example of each image frame in which the performance of the performer 1 is captured, and the previous frame is an example of a frame immediately preceding an image frame currently being processed. Furthermore, the integration result of the previous frame is an example of the skeleton recognition result finally acquired using the distance image instantly before the distance image currently being processed.

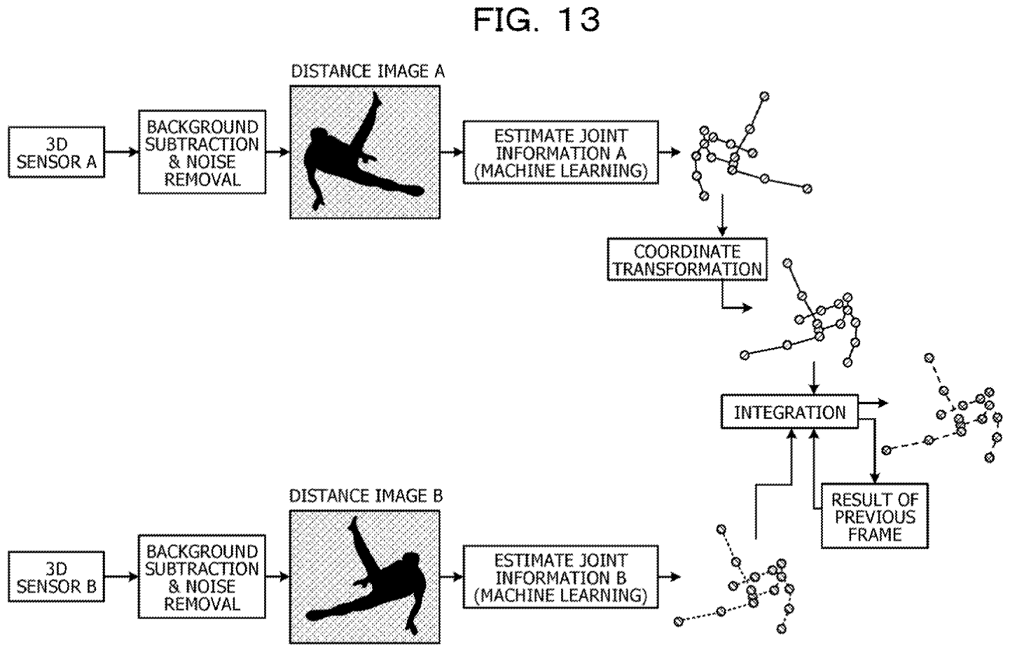

FIG. 13 is a diagram explaining skeleton recognition processing according to the second embodiment. In the processing illustrated in FIG. 13, since the processing up to the skeleton integration is similar to the processing of the first embodiment, the detailed description will be omitted. In the second embodiment, a recognition device 50 saves the result of the previous frame and reads the integration result of the previous frame when integrating the joint information based on the distance image from each sensor for the current frame.

Then, the recognition device 50 selects a joint closer to the joint in the previous frame from among respective pieces of the joint information, for each joint. For example, among three-dimensional coordinates A of the left hand included in the joint information A and three-dimensional coordinates B of the left hand included in the joint information B, the recognition device 50 selects three-dimensional coordinates closer to three-dimensional coordinates C of the left hand included in the skeleton recognition result of the previous frame. In this manner, the recognition device 50 selects a joint closer to the joint in the skeleton recognition result of the previous frame from among the joints separately included in the joint information A and the joint information B, at the time of integration for the current frame, to generate the final three-dimensional skeleton information. As a result, as compared with the first embodiment, the recognition device 50 may generate the integration result by excluding a joint that is erroneously recognized and thus may suppress a decrease in the recognition accuracy for the skeleton information.

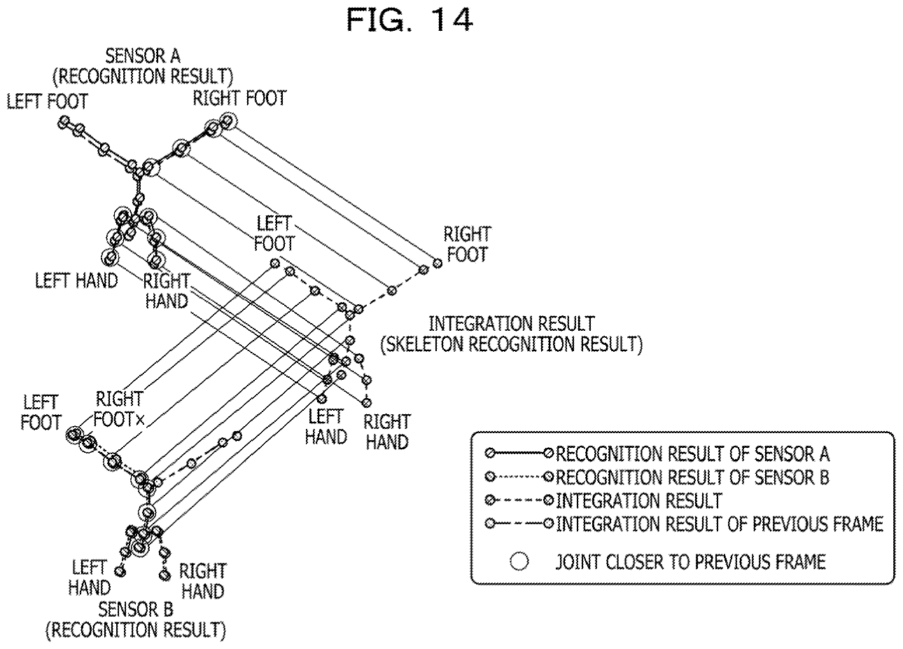

FIG. 14 is a diagram explaining a skeleton recognition result according to the second embodiment when both feet are inaccurately regarded as being on one side by the 3D laser sensor B. As illustrated in FIG. 14, in a skeleton recognition result A recognized using the distance image A of the sensor A, both hands and both feet are all precisely recognized. On the other hand, in a skeleton recognition result B recognized using the distance image B of the sensor B, the right foot is recognized at the same position as the position of the left foot, which is an inaccurate recognition result.

In this state, the recognition device 50 selects joint information closer to the skeleton recognition result of the previous frame among the joint information A, which is the skeleton recognition result of the sensor A, and the joint information B, which is the skeleton recognition result of the sensor B, for each of the 18 joints. For example, in the example in FIG. 14, the recognition device 50 selects the joint information B of the sensor B for the head, the spine, and the left foot, but selects the joint information A of the sensor A for both hands and the right foot. That is, since the difference between the right foot that is erroneously recognized in the joint information B and the skeleton recognition result of the previous frame is larger than the difference between the right foot that is exactly recognized in the joint information A and the skeleton recognition result of the previous frame, the recognition device 50 is allowed to select the coordinates of the right foot of the joint information A and to recognize exact skeleton information.

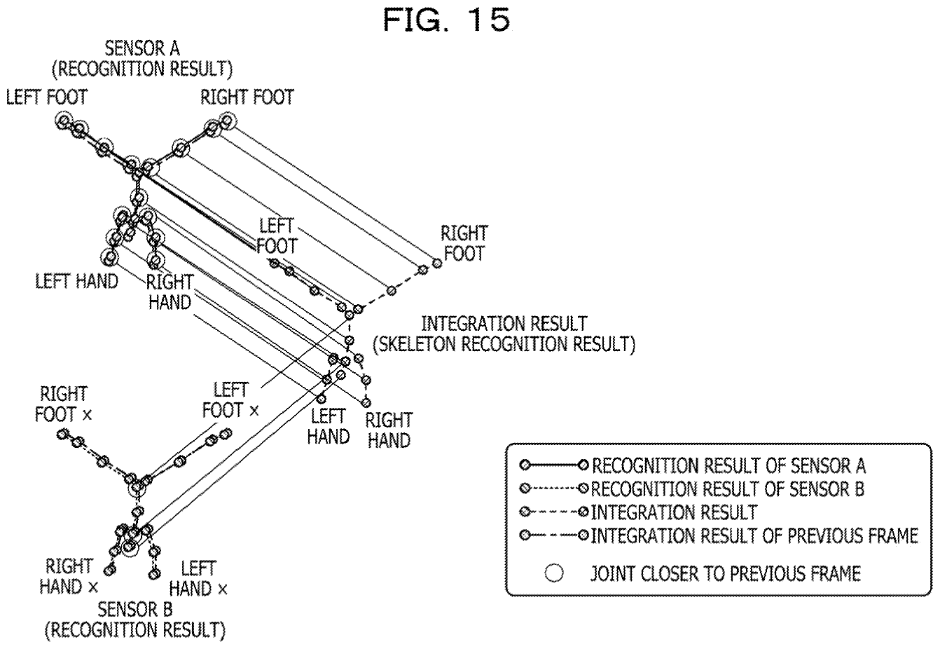

FIG. 15 is a diagram explaining a skeleton recognition result according to the second embodiment when the whole body is flipped laterally by the 3D laser sensor B. As illustrated in FIG. 15, in a skeleton recognition result A recognized using the distance image A of the sensor A, both hands and both feet are all precisely recognized. On the other hand, in a skeleton recognition result B recognized using the distance image B of the sensor B, the right hand and the left hand are laterally reversed, and additionally, the right foot and the left foot are recognized at positions laterally reversed, which is an inaccurate recognition result.

In this state, the recognition device 50 selects joint information closer to the skeleton recognition result of the previous frame among the joint information A, which is the skeleton recognition result of the sensor A, and the joint information B, which is the skeleton recognition result of the sensor B, for each of the 18 joints. For example, in the example in FIG. 15, the recognition device 50 selects the joint information B of the sensor B for the head, the spine, and the pelvis, but selects the joint information A of the sensor A for both hands and both feet. That is, since both hands and both feet that are erroneously recognized in the joint information B are recognized in a direction completely different from the direction in the previous frame, and the difference with the previous frame is very large, the recognition device 50 is allowed to select the coordinates of both hands and both feet of the joint information A and to recognize exact skeleton information.

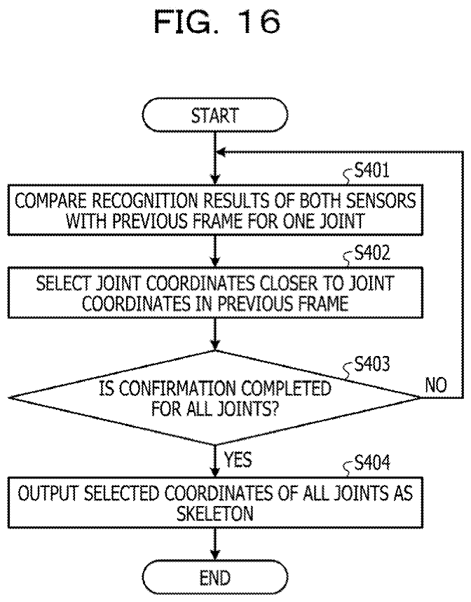

FIG. 16 is a flowchart illustrating a flow of integration processing according to the second embodiment. As illustrated in FIG. 16, the recognition device 50 compares the recognition results of both of the sensors with the previous frame for one joint (S401) and selects joint coordinates closer to the joint coordinates in the previous frame (S402).

Then, the recognition device 50 repeats S401 and subsequent steps until the selection of the joint coordinates is completed for all the joints (S403: No) and, when the joint coordinates have been selected for all the joints (S403: Yes), outputs the selected coordinates of all the joints as the skeleton position (S404).

### Third Embodiment

Incidentally, in the approach according to the second embodiment, when the deviation between respective skeletons after the coordinate transformation is large due to the calibration deviation or the sensor distortion, a precise skeleton is not obtained after the integration in some cases. For example, a straight joint may look as if being bent, or it may look as if vibration is happening because selected sensors are switched for each frame.

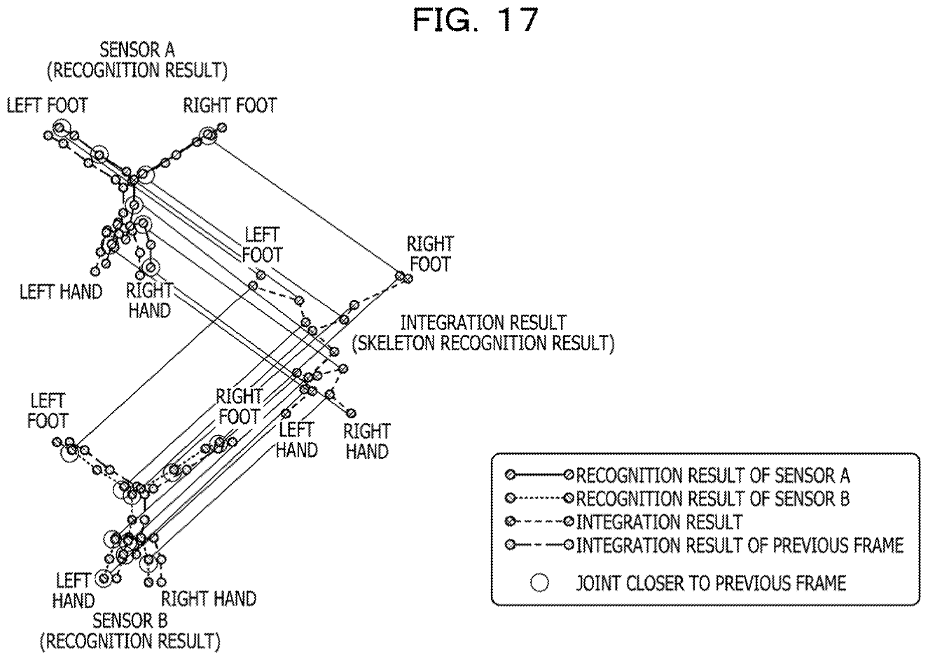

FIG. 17 is a diagram explaining a skeleton recognition result when a deviation between sensors is large. Similar to the second embodiment, here, in order to make the explanation easy to understand, the joint information estimated using the distance image will be described using the skeleton position obtained by plotting each joint included in the relevant piece of the joint information.

As illustrated in FIG. 17, a skeleton recognition result A recognized using the distance image A of the sensor A and a skeleton recognition result B recognized using the distance image B of the sensor B are both recognized in the precise direction. However, as illustrated in FIG. 17, the skeleton recognition result A is deviated as a whole to the right from the skeleton recognition result of the previous frame, and the skeleton recognition result B is deviated as a whole to the left from the skeleton recognition result of the previous frame, which causes a large deviation between the skeleton recognition result A and the skeleton recognition result B. When such recognition results are integrated by the approach of the second embodiment, the coordinates of each joint will be selected from the skeleton recognition results A and B that are deviated from each other. As a consequence, in the second embodiment, when the deviation between respective skeletons after the coordinate transformation is large due to calibration deviation or sensor distortion, a skeleton recognition result with an irregular shape in which the selected skeleton recognition result (A or B) is different for each joint is sometimes obtained in a case where the deviations of the skeleton recognition result A and the skeleton recognition result B from the previous frame are about the same as each other.

Thus, in a third embodiment, the skeleton recognition accuracy is improved by determining an average value as the joint position when both of the sensor results have close distances to the previous frame that are less than a threshold value and selecting a sensor result closer to the sensor result in the previous frame as the joint position when both of the sensor results have far distances to the previous frame that are equal to or greater than the threshold value. Note that, when the joint position closer to the joint position in the previous frame is selected, the final joint position may be determined after correcting the selected joint position using a value indicating a deviation from each sensor of a joint for which the average has been employed.

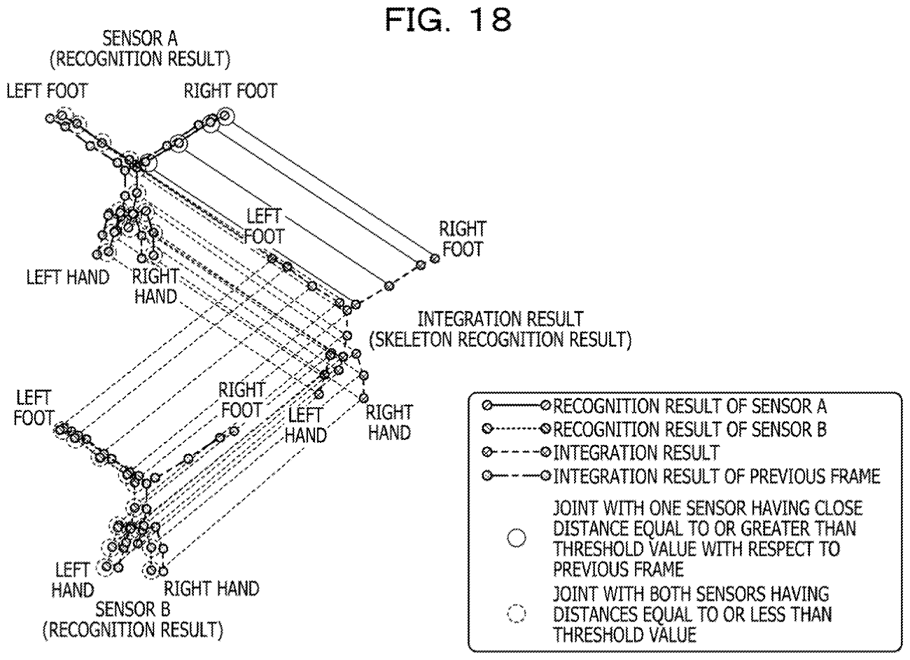

FIG. 18 is a diagram explaining integration processing according to the third embodiment. FIG. 18 illustrates an example in which the deviation between the skeleton recognition result A of the sensor A and the skeleton recognition result B of the sensor B is large, similarly to FIG. 17. In this state, it is assumed that differences of the indirect positions other than the right foot with respect to the previous frame in each of the skeleton recognition result A and the skeleton recognition result B of the joints other than the right foot are less than the threshold value, and the position of the right foot has a difference with respect to the previous frame equal to or greater than the threshold value. In this case, a recognition device 50 determines the average value of the skeleton recognition result A of the sensor A and the skeleton recognition result B of the sensor B, as the joint position for the joints other than the right foot and determines coordinates closer to the coordinates in the previous frame among the skeleton recognition result A of the sensor A and the skeleton recognition result B of the sensor B, as the joint position for the right foot.

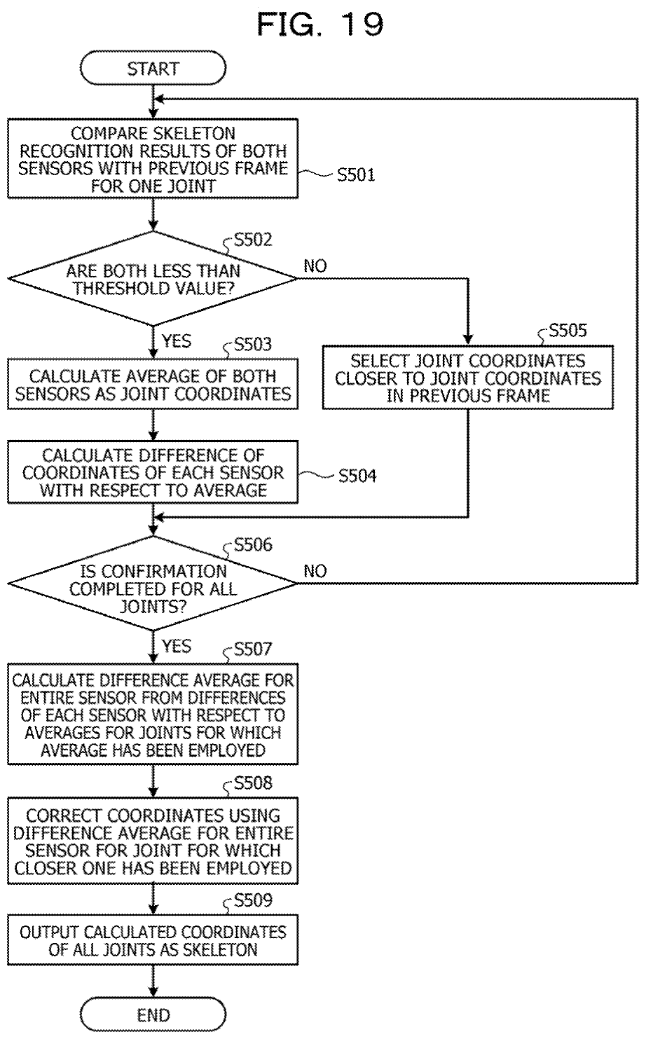

FIG. 19 is a flowchart illustrating a flow of the integration processing according to the third embodiment. Here, description will be given by taking an example in which, when the joint position closer to the joint position in the previous frame is selected, processing of correcting the selected joint position using a value indicating a deviation from each sensor of a joint for which the average has been employed is incorporated.

As illustrated in FIG. 19, the recognition device 50 compares the skeleton recognition results of both of the sensors with the previous frame for one joint (S501) and verifies whether or not both are less than the threshold value (S502).

Then, when both are less than the threshold value (S502: Yes), the recognition device 50 calculates the average of both of the sensors as the joint coordinates (S503). Subsequently, the recognition device 50 calculates the difference between the average value and each skeleton recognition result for the joint for which the average has been calculated (S504).

On the other hand, when any of the skeleton recognition results is equal to or greater than the threshold value (S502: No), the recognition device 50 selects joint coordinates closer to the joint coordinates in the previous frame (S505).

Thereafter, the recognition device 50 repeats S501 and subsequent steps until the processing is completed for all the joints (S506: No) and, when the processing is completed for all the joints (S506: Yes), calculates a difference average for the entire sensor from the differences of each sensor with respect to the average values for joints for which the average has been employed (S507).

Then, the recognition device 50 corrects the coordinates of the joint closer to the coordinates in the previous frame, using the difference average for the entire sensor (S508). Thereafter, the recognition device 50 outputs the calculated coordinates of all the joints as a skeleton recognition result (S509).

Here, the correction of the coordinates selected as being closer to the coordinates in the previous frame will be described in detail. The recognition device 50 acquires a coordinate difference of a joint (corrected joint) for which the average has been employed, with respect to the skeleton recognition result of each sensor before the correction and calculates the difference average between before and after the correction for each sensor. For example, the recognition device 50 performs the calculation by the equation as follows. Note that the difference is calculated for a difference in xyz coordinates.

Difference of Sensor A=Corrected Coordinates−Uncorrected Coordinates of Sensor A

Difference of Sensor B=Corrected Coordinates−Uncorrected Coordinates of Sensor B

Average Difference of Sensor A=(Sum of Differences of Respective Joints for Sensor A)/(Number of Joints for which Average has been Employed for Sensor A)

Average Difference of Sensor B=(Sum of Differences of Respective Joints for Sensor B)/(Number of Joints for which Average has been Employed for Sensor B)

Thereafter, the recognition device 50 corrects the joint selected as being closer to the joint in the previous frame, using the above calculation result for the average difference, as in the following equation.

(When Coordinates of Sensor A are Selected) Corrected Joint of Sensor A=Uncorrected Coordinates of Sensor A+Average Difference of Sensor A

(When Coordinates of Sensor B are Selected) Corrected Joint of Sensor B=Uncorrected Coordinates of Sensor B+Average Difference of Sensor B

In the above manner, the joint for which one of the sensors has been selected may be shifted by the same amount as the averaged joint, and a skeleton in which the joints are connected at the precise positions may be recognized. Note that, although an example of determining the average value as the joint position when both of the sensor results have close distances to the previous frame that are less than the threshold value has been described, the average value may be calculated when either one is close, and a sensor result closer to the previous frame may be selected as the joint position when both are far.

### Fourth Embodiment

While the embodiments of the present invention have been described above, the present invention may be carried out in a variety of different modes in addition to the above-described embodiments.

### Application Examples

In the above embodiments, the gymnastics competition has been described as an example, but the embodiments are not limited to the example and may be applied to other competitions in which athletes perform a series of techniques and referees score the techniques. Examples of other competitions include figure skating, rhythmic gymnastics, cheerleading, swimming diving, karate kata, and mogul air. Furthermore, the embodiments may be applied not only to sports but also to, for example, posture detection for drivers of trucks, taxis, trains, or the like, and posture detection for pilots.

### Skeleton Information

In addition, in the above embodiments, an example of learning the position of each of the 18 joints has been described, but the embodiments are not limited to the example, and one or more joints may be designated for learning. Furthermore, in the above embodiments, the position of each joint has been exemplified and described as an example of the skeleton information, but the embodiments are not limited to the example. Various sorts of information may be adopted as long as the information can be defined in advance, such as the angle of each joint, the orientation of limbs, and the orientation of the face.

In addition, in the first embodiment, an example of performing coordinate transformation on one joint position so as to adjust the one joint position to the coordinate system of the other joint position has been described, but the coordinate transformation is not limited to this example. For example, the coordinate systems of both of the joint positions may be transformed and integrated so as to form another coordinate system different from the two coordinate systems. Furthermore, in the second embodiment, an example using the skeleton recognition result of the immediately preceding frame instantly before the current frame has been described, but the skeleton recognition result is not limited to the immediately preceding and need only be before the current frame.

### Numerical Values, Directions, Etc.

The numerical values and the like used in the above embodiments are merely examples, do not limit the embodiments, and may be optionally set and changed. Furthermore, in the above embodiments, the heat map images in the two directions have been exemplified and described, but the embodiments are not limited to the example, and heat map images in three or more directions may be targeted. In addition, the installation positions and number of the respective 3D laser sensors are also examples, and the 3D laser sensors may be installed in any directions as long as the 3D laser sensors are in different directions.

### Learning Model

A learning algorithm such as a neural network may be adopted for the above-described learned learning model. Furthermore, in the above embodiments, the learning model that recognizes the front heat map image and the right above heat map image has been exemplified, but the learning model is not limited to this learning model. For example, a learning model that recognizes the front heat map image and a parallax heat map image may be adopted.

The heat map image in the front direction is a heat map image from the viewpoint (reference viewpoint) of the distance image itself to be given to input. The parallax heat map image is a heat map image from a parallax position, which is a heat map image from a virtual viewpoint supposed at a position translated and rotated by any numerical value with respect to the reference viewpoint.

Note that the “front” denotes the viewpoint of the distance image itself to be given to input as in the first embodiment. As a relative positional relationship of the “parallax position” with respect to the “front” with reference to this viewpoint, the rotation matrix has no change (=rotation 0° in any of the X, Y, and Z axes) and the translation gives a position β moved in the side direction from the “front”. Note that β depends on how much the heat map of the position moved to the side is learned during learning. Therefore, for example, in a case where the heat map is learned on the supposition of a position obtained by moving the parallax position by 100 mm in the positive direction of the X axis with respect to the front, the translation is [100, 0, 0]. For example, the translation is [100, 0, 0] and the rotation is [0, 0, 0].

Furthermore, in the above embodiments, an example using the learning model that recognizes various types of heat map images from the distance image has been described, but the learning model is not limited to this example. For example, a learning model to which a neural network is applied, which has been learned to directly estimate the 18 joint positions from the distance image, may be adopted.

### Information Indicating Relative Positional Relationship of Virtual Viewpoints

In the above embodiments, an example of calculating the three-dimensional skeleton position using the heat map images from the reference viewpoint and the heat map images from the virtual viewpoint supposed at the position translated and rotated by any numerical value with respect to the reference viewpoint has been described. However, other information may be used as long as the information indicates a relative positional relationship of virtual viewpoints, and an optionally set rotation matrix value or translation may be used. Here, with reference to a coordinate system A with one virtual viewpoint, information involved to match a coordinate system B with the other virtual viewpoint with the coordinate system A is translation [X, Y, Z] and a rotation matrix.

In the case of the first embodiment, the “front” is the viewpoint of the distance image itself to be given to input. As a relative positional relationship of the “right above” with respect to the “front” with reference to this viewpoint, the rotation matrix gives rotation of −90 degrees about the X axis, and the translation gives the Z value of the center of gravity obtained from the distance image in the Z-axis direction and the Y value+α of the center of gravity obtained from the distance image in the Y-axis direction. Note that since αdepends on which viewpoint heat map has been learned during learning, for example, in a case where the right above heat map image has been learned as a heat map image viewed from a position 5700 mm right above the center of gravity of the human area during learning, α=5700 mm is given. For example, in the first embodiment, the translation is [0, α, center of gravity Z] and the rotation is [−90, 0, 0].

### System

Pieces of information including a processing procedure, a control procedure, a specific name, and various types of data or parameters described above or illustrated in the drawings may be optionally changed unless otherwise specified.

Furthermore, each component of each device illustrated in the drawings is functionally conceptual and does not necessarily have to be physically configured as illustrated in the drawings. For example, specific forms of distribution and integration of each device are not limited to those illustrated in the drawings. That is, all or a part of the devices may be configured by being functionally or physically distributed or integrated in optional units depending on various types of loads, usage situations, or the like. Furthermore, each 3D laser sensor may be built in each device or may be connected by communication or the like as an external device of each device. Note that the distance image acquisition unit 61 is an example of an acquisition unit that acquires the distance image, and the heat map recognition unit 62, the two-dimensional calculation unit 63, and the three-dimensional calculation unit 64 are an example of an acquisition unit that acquires the joint information including each joint position of the subject. The calculation unit 70 is an example of a generation unit and an output unit.

Moreover, all or any part of individual processing functions performed in each device may be implemented by a central processing unit (CPU) and a program analyzed and executed by the CPU or may be implemented as hardware by wired logic.

### Hardware

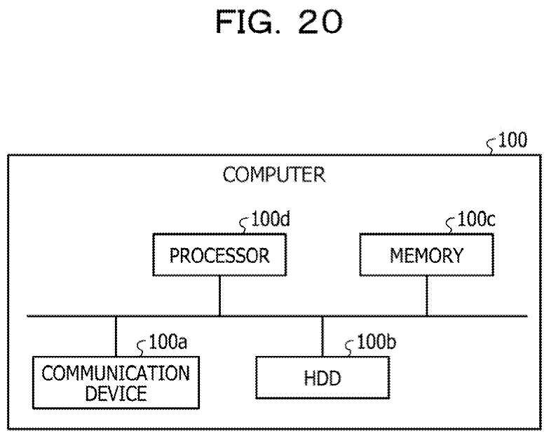

Next, a hardware configuration of the computer such as the recognition device 50 and the scoring device 90 will be described. FIG. 20 is a diagram explaining a hardware configuration example. As illustrated in FIG. 20, the computer 100 includes a communication device 100a, a hard disk drive (HDD) 100b, a memory 100c, and a processor 100d. Furthermore, the respective units illustrated in FIG. 20 are mutually connected by a bus or the like.

The communication device 100a is a network interface card or the like and communicates with another server. The HDD 100b stores programs and databases (DBs) for operating the functions illustrated in FIG. 4.

The processor 100d reads a program that executes processing similar to the processing of each processing unit illustrated in FIG. 4 from the HDD 100b or the like and loads the read program into the memory 100c, thereby operating a process that executes each function described with reference to FIG. 4 or the like. For example, this process executes functions similar to the functions of each processing unit included in the recognition device 50 and the scoring device 90. Specifically, taking the recognition device 50 as an example, the processor 100d reads a program having a function similar to the function of the estimation unit 60, the calculation unit 70, or the like from the HDD 100b or the like. Then, the processor 100d executes a process that executes processing similar to the processing of the estimation unit 60, the calculation unit 70, or the like. Note that the learning device 10 may also be processed using a similar hardware configuration.

As described above, the recognition device 50 or the scoring device 90 operates as an information processing device that executes a recognition method or a scoring method by reading and executing the program. Furthermore, the recognition device 50 or the scoring device 90 may also implement functions similar to the functions of the above-described embodiments, by reading the program described above from a recording medium by a medium reading device and executing the read program described above. Note that other programs referred to in the embodiments are not limited to being executed by the recognition device 50 or the scoring device 90. For example, the present invention may be similarly applied to a case where another computer or server executes the program, or a case where these computer and server cooperatively execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A skeleton recognition method for a computer to execute a process comprising:
acquiring distance images from each of a plurality of sensors that sense a subject from a plurality of directions;
acquiring joint information that includes joint positions of the subject for each of the plurality of sensors by using a machine learning model that estimates the joint positions from the distance images;
generating skeleton information that represents three-dimensional coordinates by integrating the joint information; and
outputting the skeleton information of the subject.

2. The skeleton recognition method according to claim 1, wherein
the generating includes:
conducting coordinate transformation on the joint information from a coordinate system of each of the plurality of sensors to a reference coordinate system; and
integrating the joint information after the coordinate transformation.

3. The skeleton recognition method according to claim 1, wherein
the generating includes acquiring an average value of the three-dimensional coordinates as each of the joint positions of the subject.

4. The skeleton recognition method according to claim 1, wherein
the generating includes selecting a joint position at the three-dimensional coordinates located at a distance closer to second skeleton information generated by using distance images acquired earlier than the distance images among the three-dimensional coordinates as each of the joint positions of the subject.

5. The skeleton recognition method according to claim 1, wherein
the generating includes:
acquiring an average of each set of the three-dimensional coordinates as each of the joint positions of the subject when a distance between the each set of the three-dimensional coordinates and second skeleton information generated by using distance images acquired earlier than the distance images is less than a threshold value; and
selecting a joint position at the three-dimensional coordinates located at a distance closer to second skeleton information generated by using distance images acquired earlier than the distance images among the three-dimensional coordinates as each of the joint positions of the subject when the distance is equal to or greater than the threshold value.

6. The skeleton recognition method according to claim 5, wherein
the generating includes:
acquiring a difference average which is an average of differences between the three-dimensional coordinates and the average value for each joint for which the average value has been acquired; and
correcting the joint position by the difference average.

7. The skeleton recognition method according to claim 1, wherein
the acquiring the joint information includes using an output result obtained by inputting each of the distance images into the machine learning model that recognizes heat map images obtained by projecting likelihoods of a plurality of the joint positions of the subject from the distance images.

8. A non-transitory computer-readable storage medium storing a skeleton recognition program that causes at least one computer to execute a process, the process comprising:
acquiring distance images from each of a plurality of sensors that sense a subject from a plurality of directions;
acquiring joint information that includes joint positions of the subject for each of the plurality of sensors by using a machine learning model that estimates the joint positions from the distance images;
generating skeleton information that represents three-dimensional coordinates by integrating the joint information; and
outputting the skeleton information of the subject.

9. The skeleton recognition method according to claim 8, wherein
the generating includes:
conducting coordinate transformation on the joint information from a coordinate system of each of the plurality of sensors to a reference coordinate system; and
integrating the joint information after the coordinate transformation.

10. The skeleton recognition method according to claim 8, wherein
the generating includes acquiring an average value of the three-dimensional coordinates as each of the joint positions of the subject.

11. The skeleton recognition method according to claim 8, wherein
the generating includes selecting a joint position at the three-dimensional coordinates located at a distance closer to second skeleton information generated by using distance images acquired earlier than the distance images among the three-dimensional coordinates as each of the joint positions of the subject.

12. The skeleton recognition method according to claim 8, wherein
the generating includes:
acquiring an average of each set of the three-dimensional coordinates as each of the joint positions of the subject when a distance between the each set of the three-dimensional coordinates and second skeleton information generated by using distance images acquired earlier than the distance images is less than a threshold value; and
selecting a joint position at the three-dimensional coordinates located at a distance closer to second skeleton information generated by using distance images acquired earlier than the distance images among the three-dimensional coordinates as each of the joint positions of the subject when the distance is equal to or greater than the threshold value.

13. The skeleton recognition method according to claim 12, wherein
the generating includes:
acquiring a difference average which is an average of differences between the three-dimensional coordinates and the average value for each joint for which the average value has been acquired; and
correcting the joint position by the difference average.

14. The skeleton recognition method according to claim 8, wherein
the acquiring the joint information includes using an output result obtained by inputting each of the distance images into the machine learning model that recognizes heat map images obtained by projecting likelihoods of a plurality of the joint positions of the subject from the distance images.

15. An information processing device comprising:
one or more memories; and
one or more processors coupled to the one or more memories and the one or more processors configured to:
acquire distance images from each of a plurality of sensors that sense a subject from a plurality of directions,
acquire joint information that includes joint positions of the subject for each of the plurality of sensors by using a machine learning model that estimates the joint positions from the distance images,
generate skeleton information that represents three-dimensional coordinates by integrating the joint information, and
output the skeleton information of the subject.
